(19) United States
(12) Patent Application Publication
(10) Pub. No.: US 2022/0413731 A1
(43) Pub. Date: Dec. 29, 2022

(54) INFORMATION PROCESSING DEVICE, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/929,303

(22) Filed: Sep. 1, 2022

Related U.S. Application Data
(63) Continuation of application No. PCT/JP2021/010412, filed on Mar. 15, 2021.

(30) Foreign Application Priority Data
Mar. 17, 2020 (JP) 2020-047036

(51) Int. Cl. G06F 3/06

(52) U.S. Cl. CPC G06F 3/0644; G06F 3/0682; G06F 3/0604

(57) ABSTRACT

An information processing device includes at least one processor. The processor performs, in a case where a size of data recorded in a data partition (DP) of a magnetic tape (30) having the data partition (DP) in which data is recorded and a reference partition (RP) in which metadata corresponding to the data is recorded, on the magnetic tape (30), reaches a predetermined value, control to record metadata corresponding to the recorded data in the reference partition (RP).

This application is a continuation application of International Application No. PCT/JP2021/010412, filed on Mar. 15, 2021, the disclosure of which is incorporated herein by reference in its entirety. Further, this application claims priority from Japanese Patent Application No. 2020-047036, filed on Mar. 17, 2020, the disclosure of which is incorporated herein by reference in its entirety.

### BACKGROUND

### 1. Technical Field

The disclosed technique relates to an information processing device, an information processing method, and an information processing program.

### 2. Description of the Related Art

The following techniques are known as techniques related to processing of recording data in each of a plurality of partitions formed on a magnetic tape. For example, JP2015-103033A discloses that the latest index is mainly written in an index partition, and a file body and a history of the index are written in a data partition. The index is updated, for example, at a regular interval or when tape media are taken out from a tape drive.

### SUMMARY

As described in JP2015-103033A, in a recent magnetic tape, partitions can be divided into, for example, a first partition in which data is recorded and a second partition in which metadata corresponding to the data is recorded.

Incidentally, in a case where data migration is performed from one magnetic tape to another magnetic tape, metadata recorded in the second partition and data corresponding to this metadata are handled as one unit (hereinafter, referred to as a data unit) and the data migration is performed in a unit of the data unit, so that data migration processing can be efficiently performed.

Here, a case where metadata group corresponding to a recorded data group is recorded in the second partition when the number of pieces of data recorded in the first partition reaches a certain value will be considered. In this case, it is assumed that the size (number of bytes) on the magnetic tape of the data unit composed of the metadata group and the data group corresponding to this metadata group is irregular because the size and compression ratio are different for each data. Here, the “size on the magnetic tape” means the size after compression in a case where data is compressed and recorded on the magnetic tape.

In a case where the size of the data unit is irregular when data migration is performed from one magnetic tape to another magnetic tape in a unit of the data unit, a relatively large free area that is insufficient to record the data unit is likely to be formed in the magnetic tape to which data is migrated, and the efficient use of the magnetic tape to which data is migrated may be hindered.

The disclosed technique has been made in view of the above circumstances, and an object thereof is to provide an information processing device, an information processing method, and an information processing program that enable efficient use of a magnetic tape to which data is migrated.

According to the disclosed technique, there is provided an information processing device comprising: at least one processor, in which the processor performs, in a case where a size of data recorded in a first partition of a magnetic tape having the first partition in which data is recorded and a second partition in which metadata corresponding to the data is recorded, on the magnetic tape, reaches a predetermined value, control to record metadata corresponding to the recorded data in the second partition.

The predetermined value may be a value obtained by dividing a capacity of the first partition by the number of wraps constituting the first partition. Alternatively, the predetermined value may be a value obtained by dividing a capacity of the first partition by a divisor of the number of wraps constituting the first partition. Alternatively, the predetermined value may be a value obtained by dividing a capacity of the first partition by a multiple of the number of wraps constituting the first partition. Alternatively, the predetermined value may be a value obtained by dividing a capacity of the first partition by a natural number. Alternatively, the predetermined value may be a divisor of a capacity of the magnetic tape. Alternatively, a plurality of sizes different from each other may be set as the predetermined value.

According to the disclosed technique, there is provided an information processing method executed by a processor provided in an information processing device, the method comprising: performing, in a case where a size of data recorded in a first partition of a magnetic tape having the first partition in which data is recorded and a second partition in which metadata corresponding to the data is recorded, on the magnetic tape, reaches a predetermined value, control to record metadata corresponding to the recorded data in the second partition.

According to the disclosed technique, there is provided an information processing program for causing a processor provided in an information processing device to execute a process comprising: performing, in a case where a size of data recorded in a first partition of a magnetic tape having the first partition in which data is recorded and a second partition in which metadata corresponding to the data is recorded, on the magnetic tape, reaches a predetermined value, control to record metadata corresponding to the recorded data in the second partition.

According to the disclosed technique, it is possible to realize efficient use of a magnetic tape to which data is migrated.

### BRIEF DESCRIPTION OF THE DRAWINGS

Exemplary embodiments according to the technique of the present disclosure will be described in detail based on the following figures, wherein:

FIG. 1 is a diagram showing an example of a configuration of a recording and reproducing system according to an embodiment of the disclosed technique;

FIG. 2 is a diagram showing a hardware configuration of an information processing device according to the embodiment of the disclosed technique;

FIG. 3 is a functional block diagram showing an example of a functional configuration of the information processing device according to the embodiment of the disclosed technique;

FIG. 4 is a diagram showing an example of a state in which data is stored in a data cache according to the embodiment of the disclosed technique and metadata is stored in a metadata DB;

FIG. 5 is a diagram showing an example of a recording method of a magnetic tape according to the embodiment of the disclosed technique;

FIG. 6 is a diagram showing an example of metadata recording timing according to a comparative example;

FIG. 7 is a diagram showing an example of metadata recording timing according to the embodiment of the disclosed technique;

FIG. 8 is a diagram showing an example of metadata recording timing according to the embodiment of the disclosed technique;

FIG. 9 is a diagram showing an example of metadata recording timing according to the embodiment of the disclosed technique; and

FIG. 10 is a flowchart showing a flow of recording processing according to the embodiment of the disclosed technique.

### DETAILED DESCRIPTION

Hereinafter, an example of an embodiment of the disclosed technique will be described with reference to the drawings. The same or equivalent constituent elements and parts are given the same reference numerals in each drawing, and overlapping description will not be repeated as appropriate.

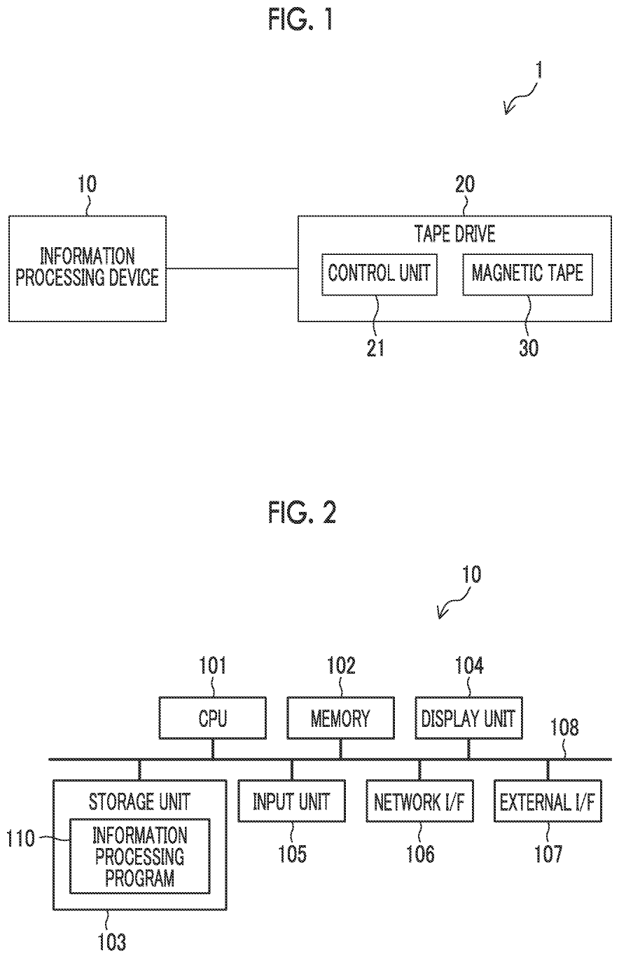

FIG. 1 is a diagram showing an example of a configuration of a recording and reproducing system 1 according to the embodiment of the disclosed technique. The recording and reproducing system 1 includes an information processing device 10 and a tape drive 20. Each tape drive 20 is connected to the information processing device 10. A magnetic tape 30 as an example of a recording medium is loaded into the tape drive 20. The tape drive 20 comprises a control unit 21 including a processor, such as a programmable logic device (PLD). The control unit 21 records (writes) data on the magnetic tape 30 loaded in the tape drive 20 and reads out data from the magnetic tape 30, on the basis of an instruction from the information processing device 10. An example of the magnetic tape 30 includes a linear tape-open (LTO) tape. The information processing device 10 performs control to record and read out data with respect to the magnetic tape 30.

FIG. 2 is a diagram showing a hardware configuration of the information processing device 10. The information processing device 10 includes a central processing unit (CPU) 101, a memory 102 serving as a temporary storage area, and a non-volatile storage unit 103. In addition, the information processing device 10 includes a display unit 104, such as a liquid crystal display, an input unit 105, such as a keyboard and a mouse, a network interface (I/F) 106 connected to a network, and an external I/F 107 to which the tape drive 20 is connected. The CPU 101, the memory 102, the storage unit 103, the display unit 104, the input unit 105, the network I/F 106, and the external I/F 107 are connected to a bus 108.

The storage unit 103 is realized by a storage medium, such as a hard disk drive (HDD), a solid state drive (SSD), or a flash memory. The storage unit 103 stores an information processing program 110. The CPU 101 reads out the information processing program 110 from the storage unit 103 and then develops the information processing program 110 into the memory 102, and executes the information processing program 110. An example of the information processing device 10 includes a server computer. The CPU 101 is an example of the processor in the disclosed technique.

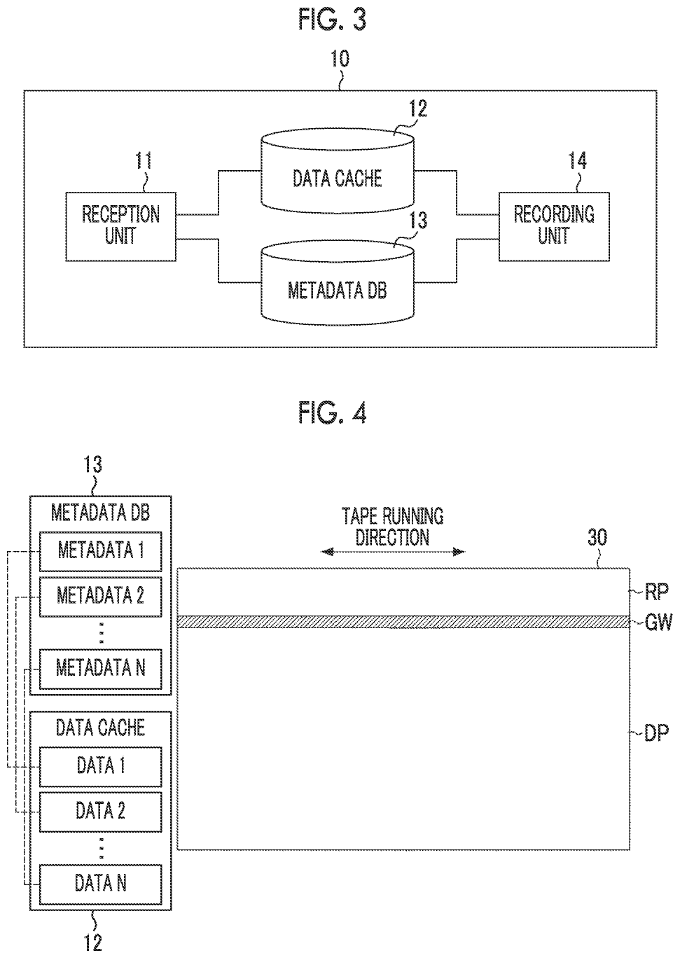

FIG. 3 is a functional block diagram showing an example of a functional configuration of the information processing device 10 in a case where data is recorded on the magnetic tape 30. As shown in FIG. 3, the information processing device 10 includes a reception unit 11 and a recording unit 14. The CPU 101 executes the information processing program 110, whereby the information processing device 10 functions as the reception unit 11 and the recording unit 14. Further, a data cache 12 and a metadata database (DB) 13 are stored in a predetermined storage area of the storage unit 103.

The reception unit 11 receives data to be recorded, which is supplied from the outside, and metadata corresponding to the data, via the network I/F 106. The reception unit 11 stores the received data in the data cache 12 and stores the metadata in the metadata DB 13. The metadata includes identification information such as a data name of corresponding data, a data size, and attribute information indicating a data attribute such as a time stamp.

FIG. 4 shows an example of a state in which data is stored in the data cache 12 and metadata is stored in the metadata DB 13. Further, FIG. 4 shows a formatted magnetic tape 30 in which data and metadata have not been recorded. As shown in FIG. 4, data is stored in the data cache 12, and metadata is stored in the metadata DB 13 in association with the data.

Meanwhile, in the magnetic tape 30, a data partition DP in which data is recorded and a reference partition RP in which metadata corresponding to the data is recorded are formed through the format. In the present embodiment, the data partition DP and the reference partition RP are storage areas separated from each other in a width direction of the magnetic tape 30 intersecting a running direction. Guard wraps GW including a plurality of wraps are formed at a boundary portion between the data partition DP and the reference partition RP. The data partition DP is an example of the first partition in the disclosed technique, and the reference partition RP is an example of the second partition in the disclosed technique.

The recording unit 14 of the information processing device 10 performs control to record the data stored in the data cache 12, in the data partition DP of the magnetic tape 30 loaded in the tape drive 20. At this time, the recording unit 14 adds the identification information of the magnetic tape 30 on which corresponding data is recorded, and management information for managing recorded data, such as information indicating a recording position on the magnetic tape 30, to metadata.

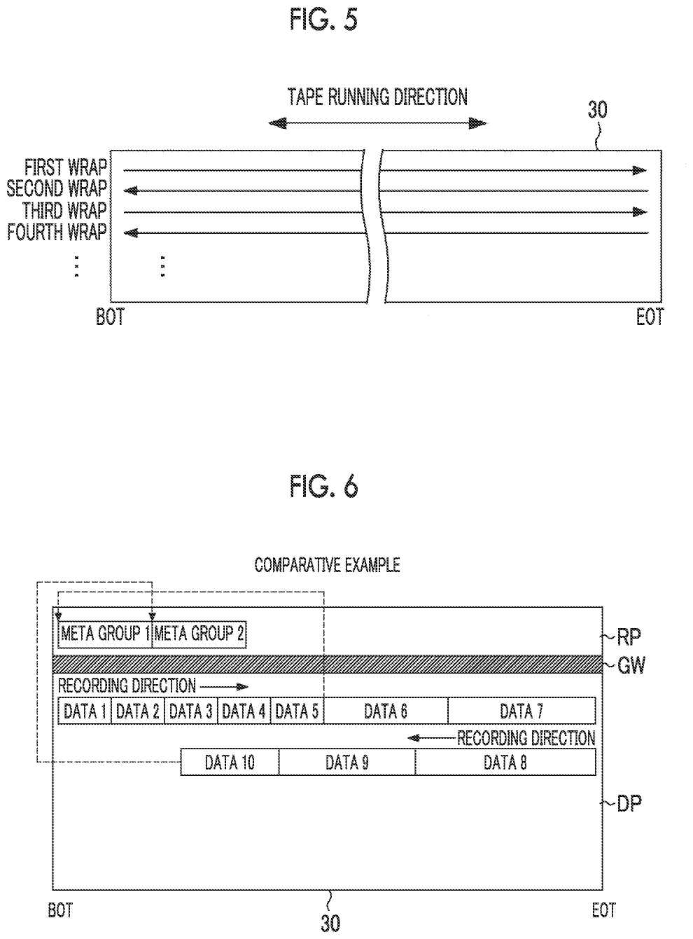

In the present embodiment, a linear recording method of recording data along the running direction of the magnetic tape 30 is employed as a method of recording data on the magnetic tape 30. As shown in FIG. 5, the magnetic tape 30 includes a plurality of wraps that are strip-shaped recording areas along the tape running direction. A recording head (not shown) provided in the tape drive 20 first records data on a first wrap from the beginning of tape (BOT) to the end of tape (EOT) (that is, in a forward direction). In a case where the data recording position reaches the EOT of the first wrap, the recording head records data on a second wrap from the EOT to the BOT (that is, in a reverse direction). In a case where the data recording position reaches the BOT of the second wrap, the recording head records data on a third wrap from the BOT to the EOT. In this way, the recording head records data on each wrap while reversing the data recording direction.

Meanwhile, in a case where data migration is performed from one magnetic tape to another magnetic tape, data migration is performed in a unit of a data unit composed of metadata recorded in the reference partition RP and data corresponding to this metadata, so that data migration processing can be efficiently performed.

Here, FIG. 6 is a diagram showing a data recording method according to a comparative example, and is a diagram showing an example of a case where a metadata group corresponding to a recorded data group is recorded in the reference partition RP when the number of pieces of data recorded in the data partition DP reaches a certain value (five in the example shown in FIG. 6).

As illustrated in FIG. 6, for example, in a case where five pieces of data from data 1 to data 5 are recorded in the data partition DP, a metadata group 1 (denoted as meta group 1 in FIG. 6) corresponding to a data group from data 1 to data 5 is recorded in the reference partition RP. After that, in a case where five pieces of data from data 6 to data 10 are recorded in the data partition DP, a metadata group 2 (denoted as meta group 2 in FIG. 6) corresponding to a data group from data 6 to data 10 is recorded in the reference partition RP.

According to the recording method shown in FIG. 6, the size on the magnetic tape 30 of the data unit composed of the metadata group and the data group corresponding to this metadata group is irregular because the size and compression ratio are different for each data. That is, the size on the magnetic tape 30 of the data unit composed of the metadata group 1 and the data group (data 1 to data 5) corresponding to the metadata group 1 and the size on the magnetic tape 30 of the data unit composed of the metadata group 2 and the data group (data 6 to data 10) corresponding to the metadata group 2 have no regularity.

In a case where the size of the data unit is irregular when data migration is performed in a unit of the data unit from one magnetic tape to another magnetic tape, the efficient use of the magnetic tape to which data is migrated may be hindered.

In that respect, the recording unit 14 of the information processing device 10 according to the present embodiment controls the timing of recording metadata in the reference partition RP as described below, to enable the efficient use of the magnetic tape to which data is migrated. That is, in a case where the size on the magnetic tape 30 of data recorded in the data partition DP of the magnetic tape 30 reaches a predetermined value, the recording unit 14 of the information processing device 10 performs control to record metadata corresponding to the recorded data in the reference partition RP.

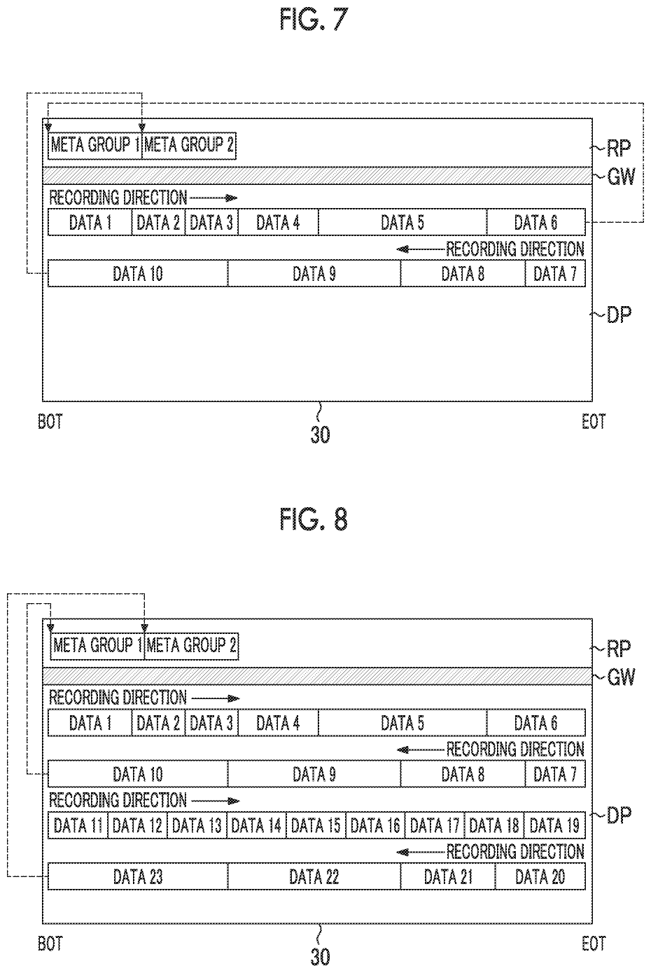

FIGS. 7, 8, and 9 are each a diagram showing a specific example of the timing of recording metadata in the reference partition RP.

As illustrated in FIG. 7, in a case where the size on the magnetic tape 30 of data recorded in the data partition DP of the magnetic tape 30 reaches a value obtained by dividing the capacity of the data partition DP by the number of wraps constituting the data partition DP, the recording unit 14 may perform control to record metadata corresponding to the recorded data in the reference partition RP. That is, in this case, in a case where the size on the magnetic tape 30 of the data recorded in the data partition DP reaches a size of one wrap, the metadata corresponding to the recorded data is recorded in the reference partition RP.

As illustrated in FIG. 7, for example, in a case where the total size of the data group from data 1 to data 6 reaches the size of one warp at the stage in which these pieces of data are recorded in the data partition DP, the recording unit 14 performs control to record the metadata group 1 (denoted as meta group 1 in FIG. 7) corresponding to the data group of these pieces of data in the reference partition RP. After that, the recording unit 14 continuously records data, and for example, in a case where the total size of the data group from data 7 to data 10 reaches the size of one warp at the stage in which these pieces of data are recorded in the data partition DP, the recording unit 14 performs control to record the metadata group 2 (denoted as meta group 2 in FIG. 7) corresponding to the data group of these pieces of data in the reference partition RP.

Alternatively, as illustrated in FIG. 8, in a case where the size on the magnetic tape 30 of data recorded in the data partition DP of the magnetic tape 30 reaches a value obtained by dividing the capacity of the data partition DP by a divisor of the number of wraps constituting the data partition DP, the recording unit 14 may perform control to record metadata corresponding to the recorded data in the reference partition RP. That is, in this case, in a case where the size on the magnetic tape 30 of the data recorded in the data partition DP reaches a size of N wraps (N is a natural number), the metadata corresponding to the recorded data is recorded in the reference partition RP.

As illustrated in FIG. 8, for example, in a case where the total size of the data group from data 1 to data 10 reaches a size of two warps at the stage in which these pieces of data are recorded in the data partition DP, the recording unit 14 performs control to record the metadata group 1 (denoted as meta group 1 in FIG. 8) corresponding to the data group of these pieces of data in the reference partition RP. After that, the recording unit 14 continuously records data, and for example, in a case where the total size of the data group from data 11 to data 23 reaches a size of two warps at the stage in which these pieces of data are recorded in the data partition DP, the recording unit 14 performs control to record the metadata group 2 (denoted as meta group 2 in FIG. 8) corresponding to the data group of these pieces of data in the reference partition RP.

In a case where the size on the magnetic tape 30 of the data recorded in the data partition DP reaches the size of three or more wraps, metadata corresponding to the recorded data may be recorded in the reference partition RP. However, it is preferable that, in a case where the size on the magnetic tape 30 of data recorded in the data partition DP reaches a size corresponding to the capacity of an even number of wraps, metadata corresponding to the recorded data is recorded in the reference partition RP. In this case, the metadata is recorded in the reference partition RP at the time when the recording position of the data recorded in the data partition DP is near the BOT. With this, the movement distance when the recording head of the tape drive 20 is relatively moved from the data recording position to the metadata recording start position can be shortened, and the overhead in the data recording processing can be restrained.

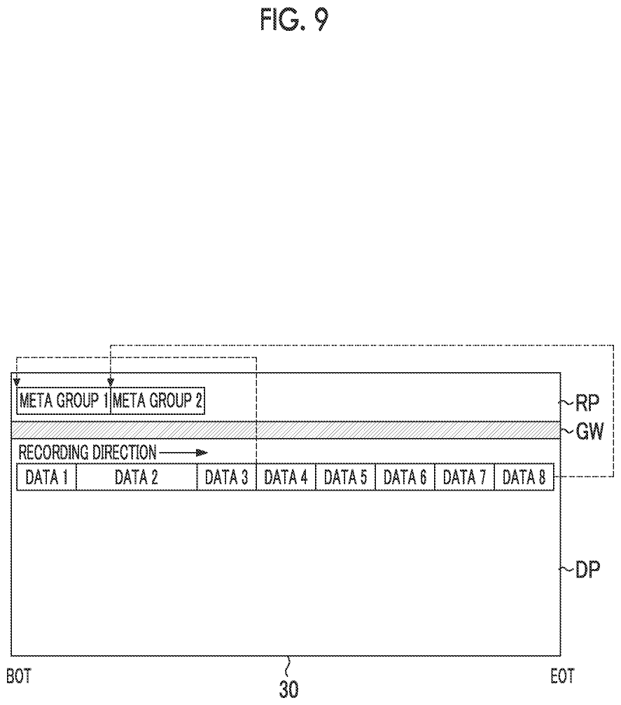

Alternatively, as illustrated in FIG. 9, in a case where the size on the magnetic tape 30 of data recorded in the data partition DP of the magnetic tape 30 reaches a value obtained by dividing the capacity of the data partition DP by a multiple of the number of wraps constituting the data partition DP, the recording unit 14 may perform control to record metadata corresponding to the recorded data in the reference partition RP. That is, in this case, in a case where the size on the magnetic tape 30 of the data recorded in the data partition DP reaches a size of 1/N wraps (N is a natural number), the metadata corresponding to the recorded data is recorded in the reference partition RP.

As illustrated in FIG. 9, for example, in a case where the total size of the data group from data 1 to data 3 reaches a size of ½ warps at the stage in which these pieces of data are recorded in the data partition DP, the recording unit 14 performs control to record the metadata group 1 (denoted as meta group 1 in FIG. 9) corresponding to the data group of these pieces of data in the reference partition RP. After that, the recording unit 14 continuously records data, and for example, in a case where the total size of the data group from data 4 to data 8 reaches the size of ½ warps at the stage in which these pieces of data are recorded in the data partition DP, the recording unit 14 performs control to record the metadata group 2 (denoted as meta group 2 in FIG. 9) corresponding to the data group of these pieces of data in the reference partition RP.

Alternatively, in a case where the size on the magnetic tape 30 of data recorded in the data partition DP of the magnetic tape 30 reaches a value obtained by dividing the capacity of the data partition DP by a natural number, the recording unit 14 may perform control to record metadata corresponding to the recorded data in the reference partition RP. That is, in this case, in a case where the size on the magnetic tape 30 of the data recorded in the data partition DP reaches a size obtained by dividing the capacity of the data partition DP into N equal parts (N is a natural number), the metadata corresponding to the recorded data is recorded in the reference partition RP.

Alternatively, in a case where the size on the magnetic tape 30 of data recorded in the data partition DP of the magnetic tape 30 reaches a size corresponding to a divisor of the capacity of the magnetic tape 30, the recording unit 14 may perform control to record metadata corresponding to the recorded data in the reference partition RP. Here, the capacity of the magnetic tape 30 may be a capacity obtained by combining the capacity of the data partition DP and the capacity of the reference partition RP.

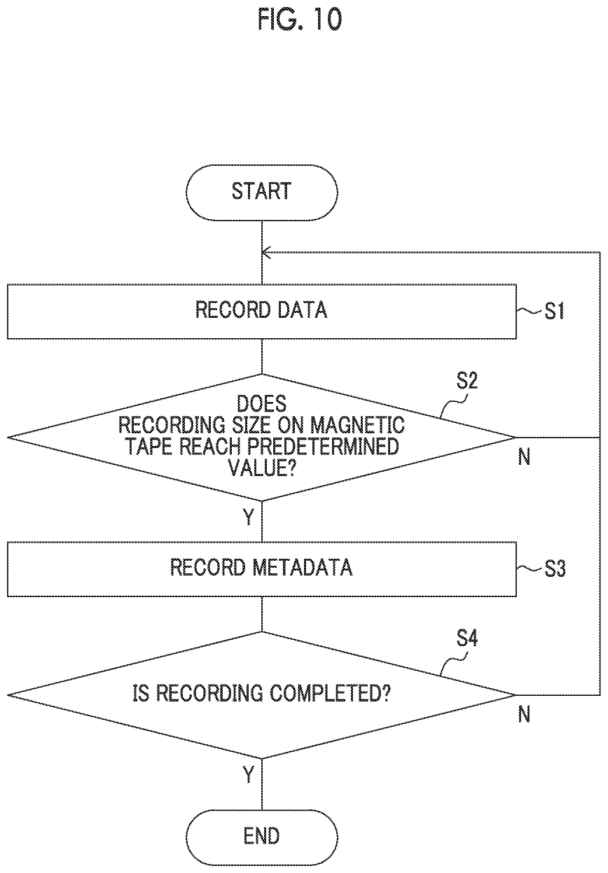

The action of the information processing device 10 will be described below. FIG. 10 is a flowchart showing an example of a flow of recording processing that is implemented by the CPU 101 executing the information processing program 110. The information processing program 110 is executed, for example, in a case where an instruction to execute recording processing is input by the user via the input unit 105. The data and metadata to be recorded on the magnetic tape 30 are received by the reception unit 11 and stored in the data cache 12 and the metadata DB 13, respectively.

In step S1, the recording unit 14 controls the control unit 21 of the tape drive 20 to record data recorded in the data cache 12, in the data partition DP.

In step S2, the recording unit 14 determines whether or not the size on the magnetic tape 30 of the data recorded in the data partition DP reaches a predetermined value. The recording unit 14 can grasp the size on the magnetic tape 30 of the data recorded in the data partition DP in real time in cooperation with the control unit 21 of the tape drive 20.

In a case where the recording unit 14 determines that the size on the magnetic tape 30 of the data recorded in the data partition DP does not reach the predetermined value, the process returns to step S1 and data recording is continued. On the other hand, in a case where the recording unit 14 determines that the size on the magnetic tape 30 of the data recorded in the data partition DP reaches the predetermined value, the process proceeds to step S3.

In step S3, the recording unit 14 controls the control unit 21 of the tape drive 20 to record metadata corresponding to the data recorded in the data partition DP, in the reference partition RP.

In step S4, the recording unit 14 determines whether or not the recording of all the data and metadata to be recorded, on the magnetic tape 30, is completed. This routine ends in a case where the recording of all the data and metadata to be recorded, on the magnetic tape 30, is completed. The processing from step S1 to step S3 is repeated until the recording of all the data and the metadata to be recorded, on the magnetic tape 30, is completed.

As described above, in a case where the size on the magnetic tape 30 of data recorded in the data partition DP of the magnetic tape 30 reaches a predetermined value, the information processing device 10 according to the embodiment of the disclosed technique performs control to record metadata corresponding to the recorded data in the reference partition RP. In this way, the metadata recording timing is determined on the basis of the size (number of bytes) on the magnetic tape of the data recorded in the data partition DP, so that it is possible to prevent the size of the data unit composed of metadata recorded in the reference partition RP and data corresponding to this metadata from being irregular. In a case where data migration is performed from one magnetic tape to another magnetic tape in a unit of the data unit, the size of the data unit is regular (for example, uniform), so that a useless free area is restrained from being formed in the magnetic tape to which data is migrated, and the efficient use of the magnetic tape to which data is migrated is possible.

In the above description, the case where, in a case where the size on the magnetic tape 30 of data recorded in the data partition DP of the magnetic tape 30 reaches a single predetermined value determined in advance, metadata corresponding to the recorded data is recorded in the reference partition RP has been exemplified, but a plurality of sizes different from each other may be set as the predetermined value. For example, each time metadata is recorded in the reference partition RP, the predetermined value may be halved from the immediately preceding value. For example, at the time when the size on the magnetic tape of data recorded in the data partition DP reaches 48 GB, the metadata corresponding to the recorded data may be recorded in the reference partition RP, and then, at the time when the size on the magnetic tape of data recorded in the data partition DP reaches 24 GB, the metadata corresponding to the recorded data may be recorded in the reference partition RP. After that, at the respective times when the size on the magnetic tape of data recorded in the data partition DP reaches 12 GB, 6 GB, 3 GB, 1.5 GB, . . . , the metadata corresponding to the recorded data may be recorded in the reference partition RP. With this, the size of the data unit composed of metadata recorded in the reference partition RP and data corresponding to this metadata is diversified, so that it is possible to promote the effect of restraining a useless free area from being formed in the magnetic tape to which data is migrated.

Further, in the above-described embodiment, the case where the CPU 101 provided in the information processing device 10 performs the above-described recording processing has been exemplified, but a processor provided in the control unit 21 of the tape drive 20 may perform the above-described recording processing.

Further, in the above-described embodiment, the case where data is recorded in the data partition DP has been exemplified, but an object including data to be saved by the user, such as document data and image data, and metadata corresponding to the data may be recorded in the data partition DP. In this case, the metadata is recorded in the reference partition RP and is also included in the object recorded in the data partition DP. Further, in this case, in a case where the size on the magnetic tape 30 of the object recorded in the data partition DP reaches a predetermined value, the metadata corresponding to the recorded object is recorded in the reference partition RP.

Further, in the above-described embodiment, for example, the following various processors can be used as the hardware structure of a processing unit that executes various kinds of processing, such as the reception unit 11 and the recording unit 14. The above-described various processors include, for example, a programmable logic device (PLD) which is a processor having a changeable circuit configuration after manufacture, such as an FPGA, and a dedicated electrical circuit which is a processor having a dedicated circuit configuration designed to perform specific processing, such as an application specific integrated circuit (ASIC), in addition to the CPU which is a general-purpose processor that executes software (programs) to function as various processing units, as described above.

One processing unit may be composed of one of these various processors or a combination of two or more processors of the same type or different types (for example, a combination of a plurality of FPGAs or a combination of a CPU and an FPGA). Alternatively, a plurality of processing units may be composed of one processor.

A first example in which a plurality of processing units are composed of one processor is an aspect in which one or more CPUs and software are combined to constitute one processor and the processor functions as the plurality of processing units, as typified by a computer, such as a client and a server. A second example is an aspect in which a processor that realizes all the functions of a system including the plurality of processing units with one integrated circuit (IC) chip is used, as typified by a system on chip (SoC). As described above, various processing units are formed of one or more of the above-described various processors as the hardware structure.

Further, as the hardware structure of these various processors, more specifically, an electric circuit (circuitry) in which circuit elements, such as semiconductor elements, are combined can be used.

Further, in the above-described embodiment, the aspect in which the information processing program 110 is stored (installed) in the storage unit 103 in advance has been described, but the disclosed technique is not limited thereto. The information processing program 110 may be provided in a form of being recorded on a recording medium, such as a compact disc read only memory (CD-ROM), a digital versatile disc read only memory (DVD-ROM), and a Universal Serial Bus (USB) memory. Alternatively, the information processing program 110 may be downloaded from an external device via a network.

The disclosure of JP2020-047036 filed on Mar. 17, 2020 is incorporated herein by reference in its entirety. In addition, all documents, patent applications, and technical standards described in the present specification are incorporated in the present specification by reference, to the same extent as in the case where each of the documents, patent applications, and technical standards is specifically and individually described.

What is claimed is:

1. An information processing device comprising:
at least one processor,
wherein the processor
performs, in a case where a size of data recorded in a first partition of a magnetic tape having the first partition in which data is recorded and a second partition in which metadata corresponding to the data is recorded, on the magnetic tape, reaches a predetermined value, control to record metadata corresponding to the recorded data in the second partition.

2. The information processing device according to claim 1,
wherein the predetermined value is a value obtained by dividing a capacity of the first partition by the number of wraps constituting the first partition.

3. The information processing device according to claim 1,
wherein the predetermined value is a value obtained by dividing a capacity of the first partition by a divisor of the number of wraps constituting the first partition.

4. The information processing device according to claim 1,
wherein the predetermined value is a value obtained by dividing a capacity of the first partition by a multiple of the number of wraps constituting the first partition.

5. The information processing device according to claim 1,
wherein the predetermined value is a value obtained by dividing a capacity of the first partition by a natural number.

6. The information processing device according to claim 1,
wherein the predetermined value is a divisor of a capacity of the magnetic tape.

7. The information processing device according to claim 1,
wherein a plurality of sizes different from each other are set as the predetermined value.

8. The information processing device according to claim 2,
wherein a plurality of sizes different from each other are set as the predetermined value.

9. The information processing device according to claim 3,
wherein a plurality of sizes different from each other are set as the predetermined value.

10. The information processing device according to claim 4,
wherein a plurality of sizes different from each other are set as the predetermined value.

11. The information processing device according to claim 5,
wherein a plurality of sizes different from each other are set as the predetermined value.

12. The information processing device according to claim 6,
wherein a plurality of sizes different from each other are set as the predetermined value.

13. An information processing method executed by a processor provided in an information processing device, the method comprising:
performing, in a case where a size of data recorded in a first partition of a magnetic tape having the first partition in which data is recorded and a second partition in which metadata corresponding to the data is recorded, on the magnetic tape, reaches a predetermined value, control to record metadata corresponding to the recorded data in the second partition.

14. A non-transitory computer-readable storage medium storing an information processing program for causing a processor provided in an information processing device to execute a process comprising:
performing, in a case where a size of data recorded in a first partition of a magnetic tape having the first partition in which data is recorded and a second partition in which metadata corresponding to the data is recorded, on the magnetic tape, reaches a predetermined value, control to record metadata corresponding to the recorded data in the second partition.
